(19) United States
(12) Patent Application Publication
(10) Pub. No.: US 2026/0021782 A1
(43) Pub. Date: Jan. 22, 2026

(54) WHEEL WELL CAVITY COVER ASSEMBLY

(71) Applicant: GM Global Technology Operations LLC, Detroit, MI (US)

(72) Inventors: Vishal Raul, Northville, MI (US); Chih-hung Yen, Bloomfield Hills, MI (US)

(21) Appl. No.: 18/775,282

(22) Filed: Jul. 17, 2024

(51) Int. Cl. B60R 19/00

(52) U.S. Cl. CPC B60R 19/00; B60R 2019/002

(57) ABSTRACT

A vehicle defines a forward direction and a rearward direction along a longitudinal axis, a rightward direction and a leftward direction along a lateral axis, and an upward direction and a downward direction along a vertical axis, and includes a wheel well cavity, a wheel positioned within the wheel well cavity, and a wheel well cavity cover assembly including a front cover plate that covers at least a front portion of a bottom opening of the wheel well cavity. The front cover plate is configured to move at least partially along the lateral axis when a front portion of the wheel is turned towards the front cover plate.

### INTRODUCTION

The subject disclosure relates to vehicles, and in particular to a wheel well cavity cover for a vehicle.

### SUMMARY

In one exemplary embodiment, a wheel well cavity cover assembly for a vehicle defining a forward direction and a rearward direction along a longitudinal axis, a rightward direction and a leftward direction along a lateral axis, and an upward direction and a downward direction along a vertical axis, the vehicle comprising a wheel within a wheel well cavity, comprises a front cover plate configured to cover at least a front portion of a bottom opening of the wheel well cavity. The front cover plate is configured to move at least partially along the lateral axis when a front portion of the wheel is turned towards the front cover plate.

In addition to one or more of the features described herein, the wheel well cavity cover further comprises a fixed cover plate positioned in the rearward direction of the front cover plate and configured to be fixed with respect to the vehicle.

In addition to one or more of the features described herein, the wheel well cavity cover further comprises a rear cover plate positioned in the rearward direction of the front cover plate and configured to cover at least a rear portion of the bottom opening of the wheel well cavity. The rear cover plate is configured to move at least partially along the lateral axis when a rear portion of the wheel is turned towards the rear cover plate.

In addition to one or more of the features described herein, the front cover plate moves in a direction along the lateral axis.

In addition to one or more of the features described herein, the front cover plate is configured to rotate about a pivot hinge.

In addition to one or more of the features described herein, the wheel well cavity cover further comprises a fixed cover plate positioned in the rearward direction of the front cover plate and configured to be fixed with respect to the vehicle. The pivot hinge is disposed on the fixed cover plate.

In addition to one or more of the features described herein, the front cover plate is structured as a plurality of shutters that rotate about the pivot hinge.

In addition to one or more of the features described herein, the front cover plate is structured as partial disk that rotates about the pivot hinge.

In addition to one or more of the features described herein, the rear cover plate comprises one or more venting apertures extending therethrough along the vertical axis.

In another exemplary embodiment, a vehicle defines a forward direction and a rearward direction along a longitudinal axis, a rightward direction and a leftward direction along a lateral axis, and an upward direction and a downward direction along a vertical axis, and comprises a wheel well cavity, a wheel positioned within the wheel well cavity, and a wheel well cavity cover assembly comprising a front cover plate that covers at least a front portion of a bottom opening of the wheel well cavity. The front cover plate is configured to move at least partially along the lateral axis when a front portion of the wheel is turned towards the front cover plate.

In addition to one or more of the features described herein, the vehicle further comprises a fixed cover plate positioned in the rearward direction of the front cover plate and fixed with respect to the vehicle.

In addition to one or more of the features described herein, the wheel well cavity cover assembly further comprises a rear cover plate positioned in the rearward direction of the front cover plate that covers at least a rear portion of the bottom opening of the wheel well cavity, and the rear cover plate is configured to move at least partially along the lateral axis when a rear portion of the wheel is turned towards the rear cover plate.

In addition to one or more of the features described herein, the vehicle further comprises a steering assembly comprising a tie-rod coupled to the wheel to turn the wheel. The front cover plate is coupled to the tie-rod and movable therewith.

In addition to one or more of the features described herein, the vehicle further comprises a steering assembly comprising a steering knuckle coupled to the wheel. The front cover plate is coupled to the steering knuckle and movable therewith.

In addition to one or more of the features described herein, the vehicle further comprises an actuation system configured to be actuated to move the front cover plate.

In addition to one or more of the features described herein, the actuation system comprises an actuator comprising a shaft movable along the lateral axis, a linkage coupled to the shaft and rotatable about a fixed hinge, and a terminal linkage coupled to the linkage and the front cover plate. When the shaft moves along the lateral axis, the linkage rotates about the fixed hinge and moves the terminal linkage, and the terminal linkage moves the front cover plate at least partially in along the lateral axis.

In addition to one or more of the features described herein, the vehicle further comprises a steering assembly comprising a control arm. The wheel well cavity cover assembly further comprises a fixed cover plate positioned in the rearward direction of the front cover plate and fixed with respect to the vehicle, and a rear cover plate positioned in the rearward direction of the fixed cover plate and configured to cover at least a rear portion of the bottom opening of the wheel well cavity. The fixed cover plate at least partially overlaps the control arm along the vertical axis. The rear cover plate is configured to move at least partially along the lateral axis when a rear portion of the wheel is turned towards the rear cover plate.

In yet another exemplary embodiment, a vehicle defines a forward direction and a rearward direction along a longitudinal axis, a rightward direction and a leftward direction along a lateral axis, and an upward direction and a downward direction along a vertical axis, and comprises a right wheel well cavity, a right wheel positioned within the right wheel well cavity, a left wheel well cavity, a left wheel positioned within the left wheel well cavity, a right wheel well cavity cover assembly, and a left wheel well cavity cover assembly. The right wheel well cavity cover assembly comprises a right front cover plate that covers at least a front portion of a right bottom opening of the right wheel well cavity, the right front cover plate configured to move at least partially in the leftward direction when a front portion of the right wheel is turned towards the leftward direction, a right fixed cover plate positioned in the rearward direction of the right front cover plate and fixed with respect to the vehicle, and a right rear cover plate positioned in the rearward direction of the right fixed cover plate that covers at least a rear portion of the right bottom opening of the right wheel well cavity, the right rear cover plate configured to move at least partially in the leftward direction when a rear portion of the right wheel is turned towards the leftward direction. The left wheel well cavity cover assembly comprises a left front cover plate that covers at least a front portion of a left bottom opening of the left wheel well cavity, the left front cover plate configured to move at least partially in the rightward direction when a front portion of the left wheel is turned towards the rightward direction, a left fixed cover plate positioned in the rearward direction of the left front cover plate and fixed with respect to the vehicle, and a left rear cover plate positioned in the rearward direction of the left fixed cover plate that covers at least a rear portion of the left bottom opening of the left wheel well cavity, the left rear cover plate configured to move at least partially in the rightward direction when a rear portion of the left wheel is turned towards the rightward direction.

In addition to one or more of the features described herein, the vehicle further comprises and actuation system. The actuation system comprises one or more actuators comprising a first right shaft, first left shaft, a second right shaft, and a second left shaft, each of which is movable along the lateral axis, a first right linkage coupled to the first right shaft and rotatable about a first right fixed hinge, a first right terminal linkage coupled to the first right linkage and the right rear cover plate, a first left linkage coupled to the first left shaft and rotatable about a first left fixed hinge, a first left terminal linkage coupled to the first left linkage and the left front cover plate, a second right linkage coupled to the second right shaft and rotatable about a second right fixed hinge, a second right terminal linkage coupled to the second right linkage and the right front cover plate, a second left linkage coupled to the second left shaft and rotatable about a second left fixed hinge, and a second left terminal linkage coupled to the second left linkage and the left front cover plate. When the first right shaft moves in the rightward direction, the first right linkage rotates about the first right fixed hinge and moves the first right terminal linkage, and the first right terminal linkage moves the right front cover plate at least partially in the leftward direction. When the second right shaft moves in the rightward direction, the second right linkage rotates about the second right fixed hinge and moves the second right terminal linkage, and the second right terminal linkage moves the right rear cover plate at least partially in the leftward direction. When the second left shaft moves in the leftward direction, the second left linkage rotates about the second left fixed hinge and moves the second left terminal linkage, and the second left terminal linkage moves the left front cover plate at least partially in the rightward direction.

In addition to one or more of the features described herein, the vehicle further comprises a steering assembly comprising a right tie-rod coupled to a right steering knuckle, the right steering knuckle being coupled to the right wheel to turn the right wheel, and a left tie-rod coupled to a left steering knuckle, the left steering knuckle being coupled to the left wheel to turn the left wheel. At least one of the right front cover plate and the right rear cover plate is coupled to the right tie-rod or the right steering knuckle and movable therewith. At least one of the left front cover plate and the left rear cover plate is coupled to the left tie-rod or the left steering knuckle and movable therewith.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle having right and left wheel well cavity cover assemblies according to one or more embodiments;

FIG. 2 is a schematic bottom view of a vehicle having right and left wheel well cavity cover assemblies according to one or more embodiments;

FIG. 3 is a front view of a steering assembly according to one or more embodiments;

FIG. 4. is a bottom perspective view of a left wheel well cavity according to one or more embodiments;

FIG. 5 is a schematic bottom view of the vehicle of FIG. 2 when the vehicle is being turned right according to one or more embodiments;

FIG. 6 is a schematic bottom view of the vehicle of FIG. 2 when the vehicle is being turned left according to one or more embodiments;

FIG. 7A is a schematic bottom view of a vehicle having a left wheel well cavity cover assembly according to one or more embodiments;

FIG. 7B is a perspective view of the left wheel well cavity cover assembly of FIG. 7A;

FIG. 8A is a schematic bottom view of a vehicle having a left wheel well cavity cover assembly according to one or more embodiments;

FIG. 8B is a perspective view of the left wheel well cavity cover assembly of FIG. 8A;

FIG. 9A is a bottom view of a left rear cover plate according to one or more embodiments;

FIG. 9B is a bottom view of a right rear cover plate according to one or more embodiments;

FIG. 9C is a perspective view of a left wheel well cavity cover assembly according to one or more embodiments;

FIG. 9D is a perspective view of a left wheel well cavity cover assembly according to one or more embodiments;

FIG. 10A is a schematic bottom view of a first actuation system according to one or more embodiments;

FIG. 10B is a schematic bottom view of a first actuation system according to one or more embodiments; and

FIG. 11 is a schematic bottom view of a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

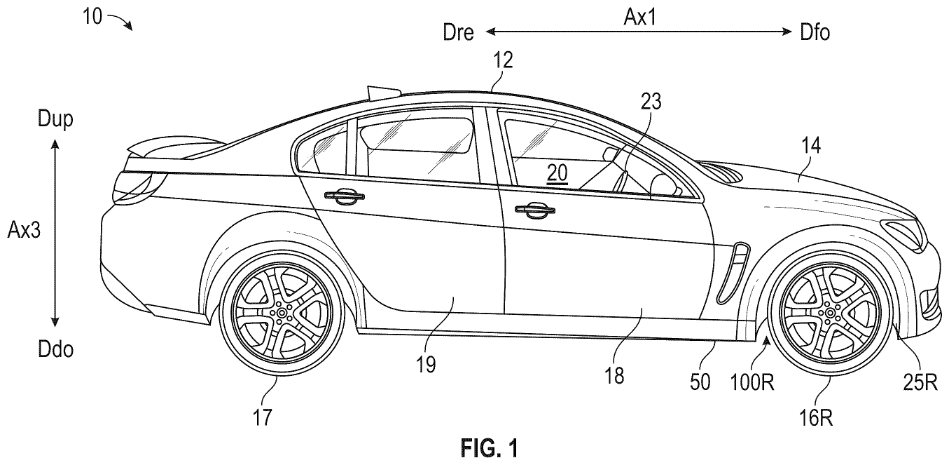

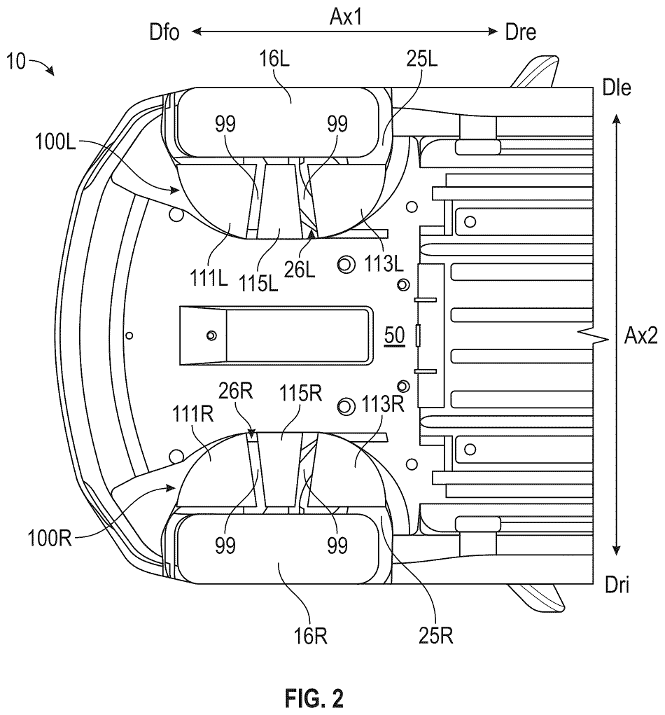

FIGS. 1 and 2 show a vehicle 10 according to a non-limiting example. The vehicle 10 extends along a longitudinal axis Ax1 and defines a forward direction Dfo and a rearward direction Dre along the longitudinal axis Ax1. The vehicle 10 further defines a leftward direction Dle and a rightward direction Dri along a lateral axis Ax2 orthogonal to the longitudinal axis Ax1, and an upward direction Dup and a downward direction Ddo along a vertical axis Ax3 orthogonal to the longitudinal axis Ax1 and the lateral axis Ax2. The vehicle 10 includes a vehicle body 12 supported on a right front wheel 16R, a left front wheel 16L, and one or more rear wheels 17. The vehicle body 12 defines, in part, a passenger compartment 20 in which a steering wheel 23 may be disposed. The right front wheel 16R and the left front wheel 16L may be steerable via the steering wheel 23. The vehicle body 12 further defines, in part, a prime mover compartment 14 that houses a prime mover. The prime mover may be, for example, an engine, a motor, or both an engine and a motor in a hybrid configuration. The vehicle body 12 may further include a front door 18 and a rear door 19. The vehicle 10 further includes an underbody 50 generally extending in a plane including the longitudinal axis Ax1 and the lateral axis Ax2.

The vehicle 10 includes a right wheel well cavity 25R in which the right front wheel 16R is positioned, and a left wheel well cavity 25L in which the left front wheel 16L is positioned. The right wheel cavity 25R defines a right bottom opening 26R and left wheel cavity 25L defines a left bottom opening 26L. The vehicle 10 may further include a right wheel well cavity cover assembly 100R positioned under the right wheel well cavity 25R to cover at least a portion of the right bottom opening 26R and a left wheel well cavity cover assembly 100L positioned under the left wheel well cavity 25L to cover at least a portion of the left bottom opening 26L. The right wheel well cavity cover assembly 100R may cover at least a portion of the right bottom opening 26R of the right wheel well cavity 25R between the right front wheel 16R and the underbody 50, and the left wheel well cavity cover assembly 100L may cover at least a portion of the right bottom opening 26L of the left wheel well cavity 25L between the left front wheel 16L and the underbody 50.

According to one or more embodiments, the right wheel well cavity cover assembly 100R includes a right fixed cover plate 115R, a right front cover plate 111R in front of the right fixed cover plate 115R, and a right rear cover plate 113R to the rear of the right fixed cover plate 115R. According to one or more embodiments, a gap 99 is formed between the right front cover plate 111R and the right fixed cover plate 115R and/or between the right fixed cover plate 115R and the right rear cover plate 113R. Alternatively, the right fixed cover plate 115R may be flush with or overlap the right front cover plate 111R and/or the right rear cover plate 113R.

According to one or more embodiments, the left wheel well cavity cover assembly 100L includes a left fixed cover plate 115L, a left front cover plate 111L in front of the left fixed cover plate 115L, and a left rear cover plate 113L to the rear of the left fixed cover plate 115L. According to one or more embodiments, a gap 99 is formed between the left front cover plate 111L and the left fixed cover plate 115L and/or between the left fixed cover plate 115L and the left rear cover plate 113L. Alternatively, the left fixed cover plate 115L may be flush with or overlap with the left front cover plate 111L and/or the left rear cover plate 113L.

The right front cover plate 111R, the right rear cover plate 113R, the right fixed cover plate 115R, the left front cover plate 111L, the left rear cover plate 113L, and/or the left fixed cover plate 115L may be formed of plastic, composite, or other materials known in the art. For example, a material that undergoes minimal deformation due to pressure may be employed.

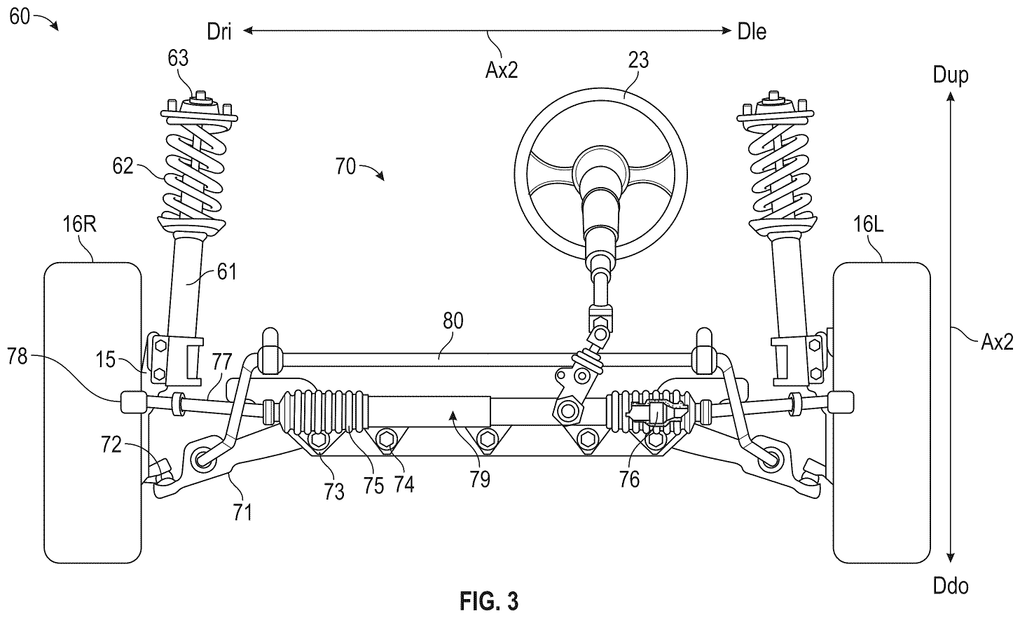

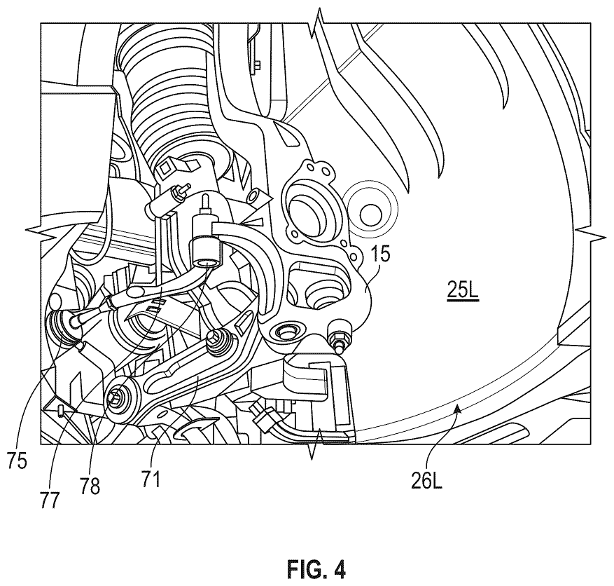

FIG. 3 shows a non-limiting example of steering assembly 70 of a vehicle 10 and structures associated with the steering assembly 70. The steering assembly 70 includes a control arm 71 coupled to a steering knuckle 15 of the right front wheel 16R and the left front wheel 16L via a ball joint 72. FIG. 4 shows a left wheel well cavity 25L in which the steering knuckle 15, the tie-rod 77, and the control arm 71 are disposed. A rack and pinion structure 79 is coupled to the control arm 71 via control arm bushings 73 and rack and pinion bushings 74. An inner socket assembly 76 is disposed at each end of the rack and pinion structure 79 coupled to a tie-rod 77, with an outer tie-rod end 78 on each of the tie-rods 77. A bellows 75 is formed over the inner socket assembly 76. An anti-sway bar 80 may be connected to the control arm 71 at positions near lateral ends thereof. The steering knuckle 15 of the right front wheel 16R and the left front wheel 16L may further be connected to a suspension assembly 60 including a strut 61, a coil spring 62, and an upper mounting plate and bearing 63.

The steering wheel 23 may be operably connected to the tie-rod 77 via the rack and pinion structure 79 and the inner socket assembly 76. The steering wheel 23 may be rotated by a driver of the vehicle 10 to move the tie-rod 77 in the rightward direction Dri and the leftward direction Dle via the rack and pinion structure 79 and the inner socket assembly 76. One or more components of the right wheel well cavity cover assembly 100R and the left wheel well cavity cover assembly 100L may be connected to the control arm 71, the tie-rod 77, and/or the steering knuckle 15.

As a non-limiting example, the right front cover plate 111R and/or the right rear cover plate 113R of the right wheel well cavity cover assembly 100R and the left front cover plate 111L and/or the left rear cover plate 113L of the left wheel well cavity cover assembly 100L may be mounted on or connected to tie-rod 77 (e.g., the outer tie-rod end 78, and/or the steering knuckle 15) so as to be movable with the tie-rod 77 and/or the steering knuckle 15. As a non-limiting example, the left fixed cover plate 115L of the left wheel well cavity cover assembly 100L and the right fixed cover plate 115R of the right wheel well cavity cover assembly 100R may be mounted on or connected to the control arm 71.

The longitudinally aligned arrangement of the right front cover plate 111R, the right fixed cover plate 115R, and the right rear cover plate 113R shown in FIG. 2 may be considered a first configuration of the right wheel well cavity cover assembly 100R, and the longitudinally aligned arrangement of the left front cover plate 111L, the left fixed cover plate 115L, and the left rear cover plate 113L shown in FIG. 2 may be considered a first configuration of the left wheel well cavity cover assembly 100L.

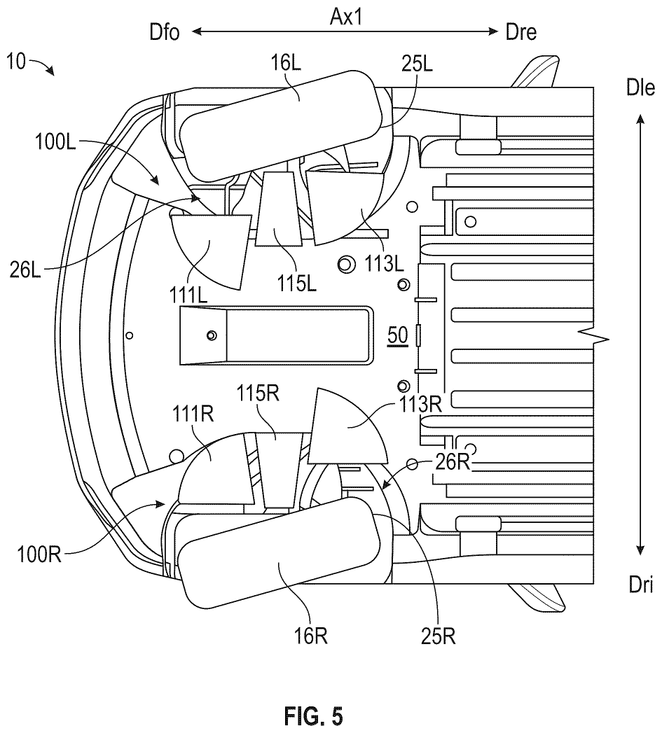

When the steering wheel 23 is operated by the driver to turn the vehicle 10 right (e.g., by rotating the steering wheel 23 clockwise), the right front wheel 16R and the left front wheel 16L are turned to the orientations shown in FIG. 5. As the right front wheel 16R and the left front wheel 16L turn to the orientations shown in FIG. 5, the right rear cover plate 113R moves in the leftward direction Dle and the left front cover plate 111L moves in the rightward direction Dri. Thus, when the vehicle 10 is turned right, the right front wheel 16R does not abut the right rear cover plate 113R and the left front wheel 16L does not abut the left front cover plate 111L.

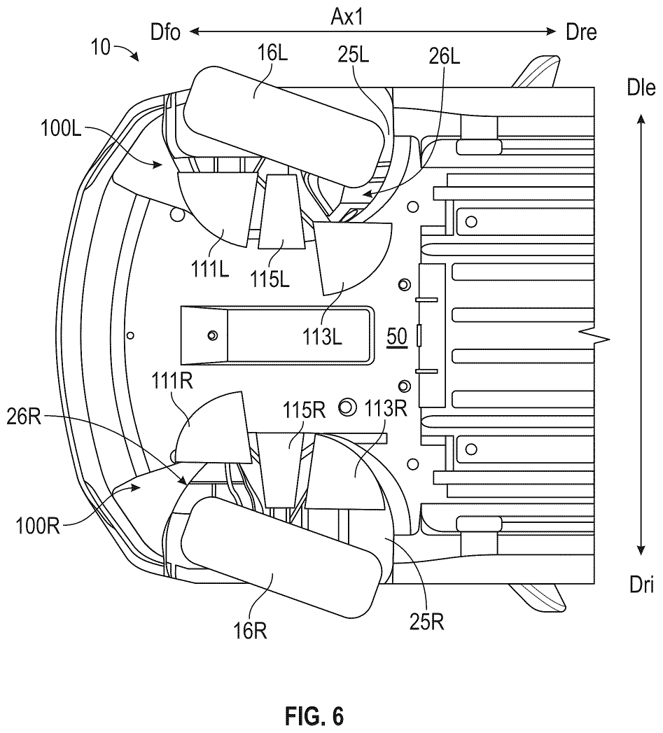

When the steering wheel 23 is operated by the driver to turn the vehicle 10 left (e.g., by rotating the steering wheel 23 counterclockwise), the right front wheel 16R and the left front wheel 16L are turned to the orientations shown in FIG. 6. As the right front wheel 16R and the left front wheel 16L turn to the orientations shown in FIG. 6, the right front cover plate 111R moves in the leftward direction Dle and the left rear cover plate 113L moves in the rightward direction Dri. Thus, when the vehicle 10 is turned left, the right front wheel 16R does not abut the right front cover plate 111R and the left front wheel 16L does not abut the left rear cover plate 113L.

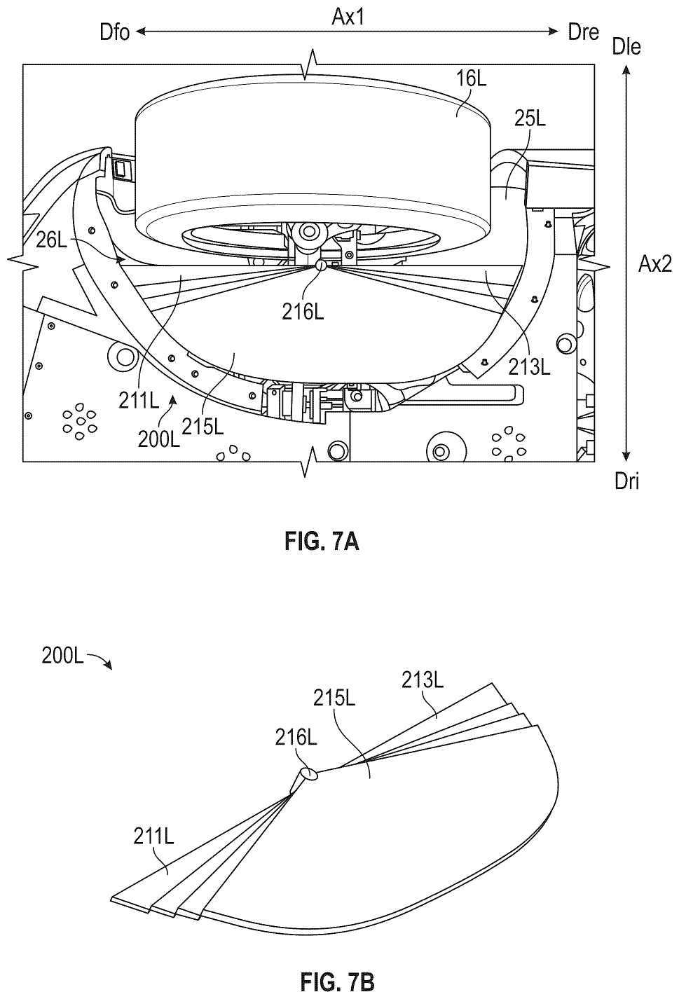

FIGS. 7A and 7B show a left wheel well cavity cover assembly 200L according to one or more embodiments. The left wheel well cavity cover assembly 200L includes a left fixed cover plate 215L with a left front cover plate 211L that is structured as a plurality of shutters on a front side of the left fixed cover plate 215L and a left rear cover plate 213L that is structured as a plurality of shutters on a rear side of the left fixed cover plate 215L. The left front cover plate 211L and/or the left rear cover plate 213L may be rotatably connected to the left fixed cover plate 215L via a pivot hinge 216L.

As a non-limiting example, the left front cover plate 211L and/or the left rear cover plate 213L of the left wheel well cavity cover assembly 200L may be mounted on or connected to tie-rod 77 (e.g., the outer tie-rod end 78) and/or the steering knuckle 15, so as to be movable with the tie-rod 77 and/or the steering knuckle 15. As a non-limiting example, the left fixed cover plate 215L of the left wheel well cavity cover assembly 200L may be mounted on or connected to the control arm 71.

The left front cover plate 211L, the left rear cover plate 213L, and/or the left fixed cover plate 215L may be formed of plastic, composite, or other materials known in the art. For example, a material that undergoes minimal deformation due to pressure may be employed.

When the steering wheel 23 is operated by the driver to turn the vehicle 10 right (e.g., by rotating the steering wheel 23 clockwise), the left front cover plate 211L rotates about the pivot hinge 216L in the rightward direction to overlap with the left fixed cover plate 215L so that the left front wheel 16L does not abut the left front cover plate 211L.

When the steering wheel 23 is operated by the driver to turn the vehicle 10 left (e.g., by rotating the steering wheel 23 counterclockwise), the left rear cover plate 213L rotates about the pivot hinge 216L in the rightward direction to overlap with the left fixed cover plate 215L so that the left front wheel 16L does not abut the left rear cover plate 213L.

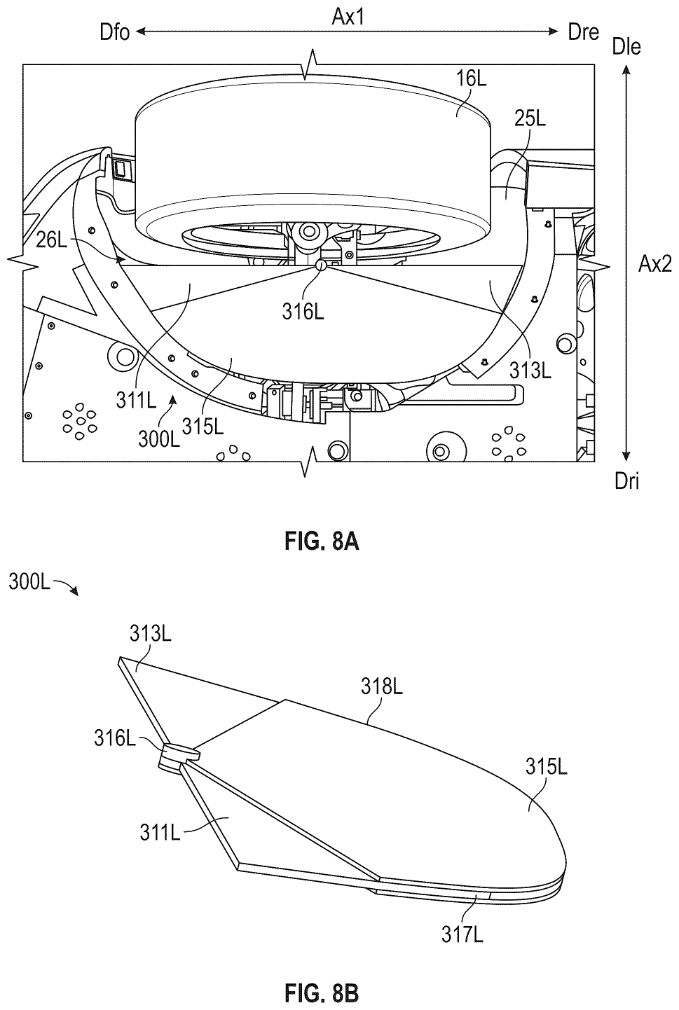

FIGS. 8A and 8B show a left wheel well cavity cover assembly 300L according to one or more embodiments. The left wheel well cavity cover assembly 300L includes a left fixed cover plate 315L with a left front cover plate 311L that is structured as a partial disk on a front side of the left fixed cover plate 315L and a left rear cover plate 313L that is structured as a partial disk on a rear side of the left fixed cover plate 315L. The left front cover plate 311L and/or the left rear cover plate 313L may be rotatably connected to the left fixed cover plate 315L via a pivot hinge 316L. According to one or more embodiments, the left front cover plate 311L and the left rear cover plate 313L may be a unitary structure that rotate together about the pivot hinge 316L.

As a non-limiting example, the left front cover plate 311L and/or the left rear cover plate 313L of the left wheel well cavity cover assembly 300L may be mounted on or connected to tie-rod 77 (e.g., the outer tie-rod end 78), and/or the steering knuckle 15, so as to be movable with the tie-rod 77 and/or the steering knuckle 15. As a non-limiting example, the left fixed cover plate 315L and/or the pivot hinge 316L of the left wheel well cavity cover assembly 300L may be mounted on or connected to the control arm 71.

When the steering wheel 23 is operated by the driver to turn the vehicle 10 right (e.g., by rotating the steering wheel 23 clockwise), the left front cover plate 311L rotates about the pivot hinge 316L in the rightward direction to rotate into a front slot 317L formed in the left fixed cover plate 315L so that the left front wheel 16L does not abut the left front cover plate 311L.

When the steering wheel 23 is operated by the driver to turn the vehicle 10 left (e.g., by rotating the steering wheel 23 counterclockwise), the left rear cover plate 313L rotates about the pivot hinge 316L in the rightward direction to rotate into a rear slot 318L formed in the left fixed cover plate 315L so that the left front wheel 16L does not abut the left rear cover plate 313L.

The right front cover plate 311R, the right rear cover plate 313R, the right fixed cover plate 215R, the left front cover plate 311L, the left rear cover plate 313L, and/or the left fixed cover plate 315L may be formed of plastic, composite, or other materials known in the art. For example, a material that undergoes minimal deformation due to pressure may be employed.

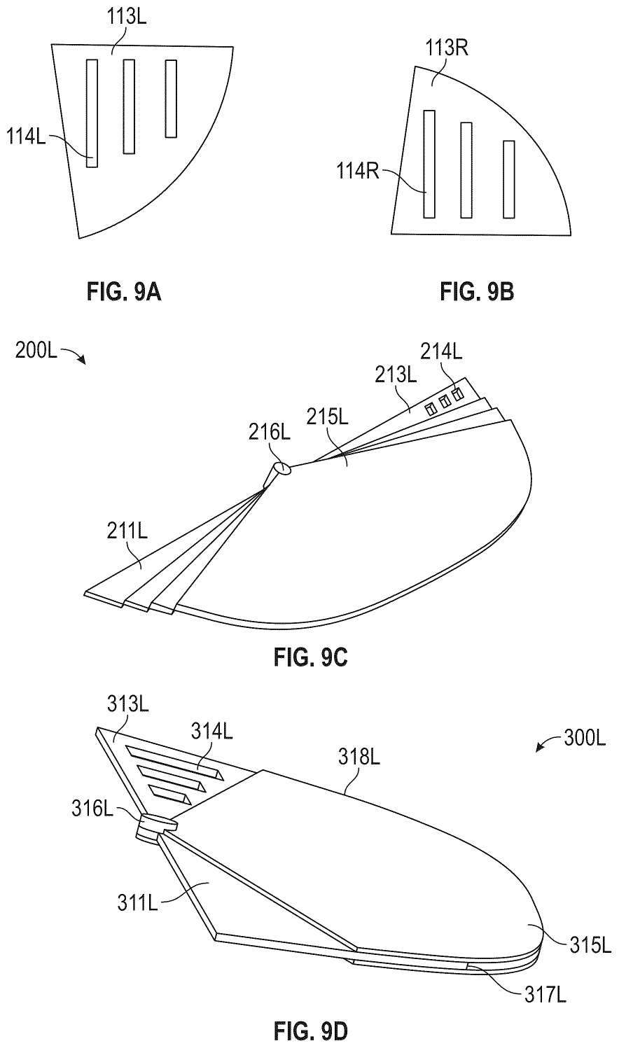

As shown in FIGS. 9A and 9B, the left rear cover plate 113L may include one or more left venting apertures 114L to allow for air and/or water within a rear portion of the left wheel well cavity 25L to exit, and the right rear cover plate 113R may include one or more right venting apertures 114R to allow for air and/or water within a rear portion of the right wheel well cavity 25R to exit. The left venting apertures 114L and the right venting apertures 114R may be sized to allow for water to pass therethrough. While FIGS. 9A and 9B show three left venting apertures 114L and three right venting apertures 114R, the present disclosure is not limited thereto, and any number of left venting aperture(s) 114L and any number of right venting aperture(s) 114R may be disposed.

As shown in FIG. 9C, the left rear cover plate 213L may include one or more left venting apertures 214L to allow for air and/or water within a rear portion of the left wheel well cavity 25L to exit, and as shown in FIG. 9D, the left rear cover plate 313L may include one or more left venting apertures 314L to allow for air and/or water within a rear portion of the left wheel well cavity 25L to exit.

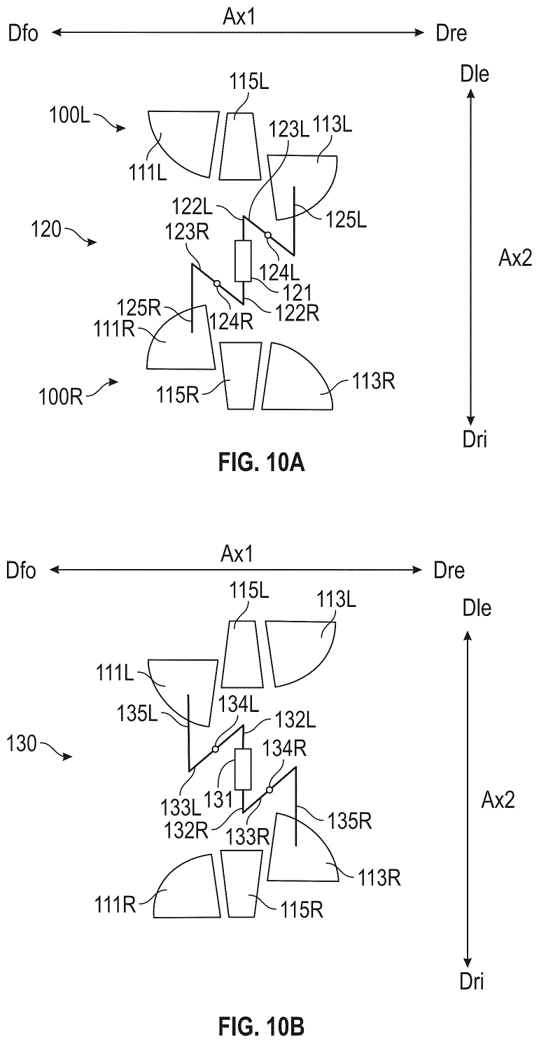

While the right wheel well cavity cover assembly 100R, the left wheel well cavity cover assembly 100L, the left wheel well cavity cover assembly 200L, and the left wheel well cavity cover assembly 200L are described above as a passive mechanism that moves with mechanisms for turning the right front wheel 16R and the left front wheel 16L, the present disclosure is not limited thereto. For example, as shown in FIGS. 10A and 10B, the vehicle 10 may include a first actuation system 120 that is actuated when the vehicle 10 is being turned left to move the left rear cover plate 113L and the right front cover plate 111R, and a second actuation system 130 that is actuated when the vehicle 10 is being turned right to move the right rear cover plate 113R and the left front cover plate 111L.

The first actuation system 120 may include a first actuator 121 with a first right shaft 122R and a first left shaft 122L. The first actuator 121 may include a motor and gears (not shown) to drive the first right shaft 122R and the first left shaft 122L to move in the rightward direction Dri and the leftward direction Dle. The right front cover plate 111R is coupled to a first right terminal linkage 125R, and the left rear cover plate 113L is coupled to a first left terminal linkage 125L. The first right shaft 122R and the first right terminal linkage 125R are coupled to opposite ends of a first right linkage 123R, and the first left shaft 122L and the first left terminal linkage 125L are coupled to opposite ends of a first left linkage 123L. The first right linkage 123R is rotatably mounted on a first right fixed hinge 124R to be rotatable about the first right fixed hinge 124R, and the first left linkage 123L is rotatably mounted on a first left fixed hinge 124L to be rotatable about the first left fixed hinge 124L. When the first actuator 121 moves the first right shaft 122R in the rightward direction Dri and the first left shaft 122L in the leftward direction Dle, the first right linkage 123R and the first left linkage 123L are rotated about the first right fixed hinge 124R and the first left fixed hinge 124L, respectively, to pull the first right terminal linkage 125R and the right front cover plate 111R coupled thereto in the leftward direction Dle and to pull the first left terminal linkage 125L and the left rear cover plate 113L coupled thereto in the leftward direction Dle.

The second actuation system 130 may include a second actuator 131 with a second right shaft 132R and a second left shaft 132L. The second actuator 131 may include a motor and gears (not shown) to drive the second right shaft 132R and the second left shaft 132L to move in the rightward direction Dri and the leftward direction Dle. The left front cover plate 111L is coupled to a second left terminal linkage 135L, and the right rear cover plate 113R is coupled to a second right terminal linkage 135R. The second right shaft 132R and the second right terminal linkage 135R are coupled to opposite ends of a second right linkage 133R, and the second left shaft 132L and the second left terminal linkage 135L are coupled to opposite ends of a second left linkage 133L. The second right linkage 133R is rotatably mounted on a second right fixed hinge 134R to be rotatable about the second right fixed hinge 134R, and the second left linkage 133L is rotatably mounted on a second left fixed hinge 134L to be rotatable about the second left fixed hinge 134L. When the second actuator 131 moves the second right shaft 132R in the rightward direction Dri and the second left shaft 132L in the leftward direction Dle, the second right linkage 133R and the second left linkage 133L are rotated about the second right fixed hinge 134R and the second left fixed hinge 134L, respectively, to pull the second right terminal linkage 135R and the right rear cover plate 113R coupled thereto in the leftward direction Dle and to pull the second left terminal linkage 135L and the left front cover plate 111L coupled thereto in the leftward direction Dle.

The first actuation system 120 and the second actuation system 130 may also be employed to move the left wheel well cavity cover assembly 200L and the left wheel well cavity cover assembly 300L. While the first actuator 121 and the second actuator 131 are shown as separate structures, according to one or more embodiments, the first actuator 121 and the second actuator 131 may be a single actuator that comprises the first right shaft 122R, the first left shaft 122L, the second right shaft 132R, and the second left shaft 132L.

The vehicle 10 may further comprise a controller (not shown) that controls the first actuator 121 and/or the second actuator 131 based on the orientations of the right front wheel 16R and/or the left front wheel 16L sensed by one or more rotational position sensors (not shown). Alternatively, the controller may receive signals from a processor within the vehicle that tracks the orientations of the right front wheel 16R and/or the left front wheel 16L.

According to one or more embodiments, the right front cover plate 111R, the right rear cover plate 113R, the left front cover plate 111L, and/or the left rear cover plate 113L may be disposed lower than the underbody 50 of the vehicle 10 to allow lateral movement thereof and overlapping the underbody 50 along the vertical axis Ax3. Alternatively, recesses or slots (not shown) may be formed in the underbody 50 to allow the right front cover plate 111R, the right rear cover plate 113R, the left front cover plate 111L, and/or the left rear cover plate 113L to move in the lateral direction overlapping the underbody 50. The right fixed cover plate 115R and/or the left fixed cover plate 115L may be aligned with the underbody 50, disposed higher or lower than the underbody 50, and/or may disposed in a plane of the right front cover plate 111R, the right rear cover plate 113R, the left front cover plate 111L, and/or the left rear cover plate 113L.

According to one or more embodiments, the left front cover plate 211L, the left rear cover plate 213L, and/or the left fixed cover plate 215L may be disposed higher than, lower than, or aligned with the underbody 50 of the vehicle 10.

According to one or more embodiments, the left front cover plate 311L, the left rear cover plate 313L, and/or the left fixed cover plate 315L may be disposed higher than, lower than, or aligned with the underbody 50 of the vehicle 10.

While only the left wheel well cavity cover assembly 200L and the left wheel well cavity cover assembly 300L are shown and described, similar structures that are flipped with respect to the longitudinal axis Ax1 may be employed as a right wheel well cavity cover assembly.

Airflow around front wheels of a vehicle may be complex. For example, turbulent flow separations around the front and rear wheels, deflectors, wheel well cavities, and suspension bars disturbing free stream airflow as the vehicle travels and aerodynamic drag associated therewith may account for over 30% of total aerodynamic drag acting on the vehicle.

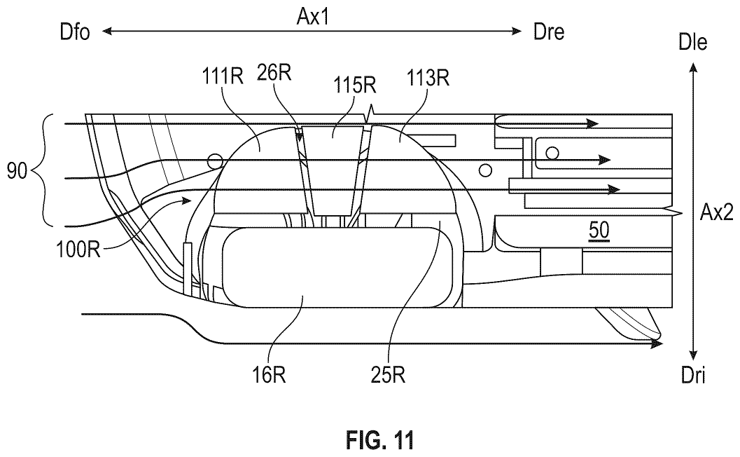

The right wheel well cavity cover assembly 100R and the left wheel well cavity cover assembly 100L, 200L, 300L according to one or more embodiments prevent at least some airflow from entering the right wheel well cavity 25R from the right bottom opening 26R and the left wheel well cavity 25L from the left bottom opening 26L, thereby resulting in a comparatively smooth flow around the right and left front wheels 16R, 16L, which may result in 2-5% reduction in the total aerodynamic drag acting on the vehicle 10, although the present disclosure is not limited to any specific reduction in the total aerodynamic drag. As a non-limiting example, as shown in FIG. 11, airflow 90 may flow under the right front cover plate 111R, the right rear cover plate 113R, and the right fixed cover plate 115R of the right wheel well cavity cover assembly 100R instead of entering the right wheel well cavity 25R. According to one or more embodiments, due to the smoother airflow, beneficially, front wheel deflectors may be reduced in size. While right wheel well cavity cover assembly 100R and the left wheel well cavity cover assembly 100L, 200L, 300L may cover portions of the right and left bottom portions 26R, 26L of the right and left wheel well cavities 25R, 25L, the right wheel well cavity cover assembly 100R and the left wheel well cavity cover assembly 100L, 200L, 300L are configured to move as the right and left front wheels 16R, 16L are turned to avoid abutting the right and left front wheels 16R, 16L.

While the right wheel well cavity cover assembly 100R and the left wheel well cavity cover assembly 100L, 200L, 300L are shown with both front and rear cover plates, according to one or more embodiments, the right wheel well cavity cover assembly 100R and/or the left wheel well cavity cover assembly 100L, 200L, 300L may have only the front cover plate(s) and may have no rear cover plate, which may allow for air in the right and left wheel well cavities 25R, 25L and/or underhood to escape from rear portions of the right and left bottom openings 26R, 26L.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A wheel well cavity cover assembly for a vehicle defining a forward direction and a rearward direction along a longitudinal axis, a rightward direction and a leftward direction along a lateral axis, and an upward direction and a downward direction along a vertical axis, the vehicle comprising a wheel within a wheel well cavity, the wheel well cavity cover assembly comprising a front cover plate configured to cover at least a front portion of a bottom opening of the wheel well cavity, wherein the front cover plate is configured to move at least partially along the lateral axis when a front portion of the wheel is turned towards the front cover plate.

2. The wheel well cavity cover assembly of claim 1, further comprising a fixed cover plate positioned in the rearward direction of the front cover plate and configured to be fixed with respect to the vehicle.

3. The wheel well cavity cover assembly of claim 1, further comprising a rear cover plate positioned in the rearward direction of the front cover plate and configured to cover at least a rear portion of the bottom opening of the wheel well cavity, wherein the rear cover plate is configured to move at least partially along the lateral axis when a rear portion of the wheel is turned towards the rear cover plate.

4. The wheel well cavity cover assembly of claim 1, wherein the front cover plate moves in a direction along the lateral axis.

5. The wheel well cavity cover assembly of claim 1, wherein the front cover plate is configured to rotate about a pivot hinge.

6. The wheel well cavity cover assembly of claim 5, further comprising a fixed cover plate positioned in the rearward direction of the front cover plate and configured to be fixed with respect to the vehicle, wherein the pivot hinge is disposed on the fixed cover plate.

7. The wheel well cavity cover assembly of claim 5, wherein the front cover plate is structured as a plurality of shutters that rotate about the pivot hinge.

8. The wheel well cavity cover assembly of claim 5, wherein the front cover plate is structured as partial disk that rotates about the pivot hinge.

9. The wheel well cavity cover assembly of claim 3, wherein the rear cover plate comprises one or more venting apertures extending therethrough along the vertical axis.

10. A vehicle defining a forward direction and a rearward direction along a longitudinal axis, a rightward direction and a leftward direction along a lateral axis, and an upward direction and a downward direction along a vertical axis, the vehicle comprising:
a wheel well cavity;
a wheel positioned within the wheel well cavity; and
a wheel well cavity cover assembly comprising a front cover plate that covers at least a front portion of a bottom opening of the wheel well cavity,
wherein the front cover plate is configured to move at least partially along the lateral axis when a front portion of the wheel is turned towards the front cover plate.

11. The vehicle of claim 10, further comprising a fixed cover plate positioned in the rearward direction of the front cover plate and fixed with respect to the vehicle.

12. The vehicle of claim 10, wherein the wheel well cavity cover assembly further comprises a rear cover plate positioned in the rearward direction of the front cover plate that covers at least a rear portion of the bottom opening of the wheel well cavity, and wherein the rear cover plate is configured to move at least partially along the lateral axis when a rear portion of the wheel is turned towards the rear cover plate.

13. The vehicle of claim 10, further comprising a steering assembly comprising a tie-rod coupled to the wheel to turn the wheel, wherein the front cover plate is coupled to the tie-rod and movable therewith.

14. The vehicle of claim 10, further comprising a steering assembly comprising a steering knuckle coupled to the wheel, and wherein the front cover plate is coupled to the steering knuckle and movable therewith.

15. The vehicle of claim 10, further comprising an actuation system configured to be actuated to move the front cover plate.

16. The vehicle of claim 15, wherein the actuation system comprises:
an actuator comprising a shaft movable along the lateral axis,
a linkage coupled to the shaft and rotatable about a fixed hinge, and
a terminal linkage coupled to the linkage and the front cover plate,
wherein, when the shaft moves along the lateral axis, the linkage rotates about the fixed hinge and moves the terminal linkage, and the terminal linkage moves the front cover plate at least partially in along the lateral axis.

17. The vehicle of claim 10, further comprising:
a steering assembly comprising a control arm,
wherein the wheel well cavity cover assembly further comprises a fixed cover plate positioned in the rearward direction of the front cover plate and fixed with respect to the vehicle, and a rear cover plate positioned in the rearward direction of the fixed cover plate and configured to cover at least a rear portion of the bottom opening of the wheel well cavity,
wherein the fixed cover plate at least partially overlaps the control arm along the vertical axis, and
wherein the rear cover plate is configured to move at least partially along the lateral axis when a rear portion of the wheel is turned towards the rear cover plate.

18. A vehicle defining a forward direction and a rearward direction along a longitudinal axis, a rightward direction and a leftward direction along a lateral axis, and an upward direction and a downward direction along a vertical axis, the vehicle comprising:
a right wheel well cavity;
a right wheel positioned within the right wheel well cavity;
a left wheel well cavity;
a left wheel positioned within the left wheel well cavity;
a right wheel well cavity cover assembly comprising:
a right front cover plate that covers at least a front portion of a right bottom opening of the right wheel well cavity, the right front cover plate configured to move at least partially in the leftward direction when a front portion of the right wheel is turned towards the leftward direction,
a right fixed cover plate positioned in the rearward direction of the right front cover plate and fixed with respect to the vehicle, and
a right rear cover plate positioned in the rearward direction of the right fixed cover plate that covers at least a rear portion of the right bottom opening of the right wheel well cavity, the right rear cover plate configured to move at least partially in the leftward direction when a rear portion of the right wheel is turned towards the leftward direction; and
a left wheel well cavity cover assembly comprising:
a left front cover plate that covers at least a front portion of a left bottom opening of the left wheel well cavity, the left front cover plate configured to move at least partially in the rightward direction when a front portion of the left wheel is turned towards the rightward direction,
a left fixed cover plate positioned in the rearward direction of the left front cover plate and fixed with respect to the vehicle, and
a left rear cover plate positioned in the rearward direction of the left fixed cover plate that covers at least a rear portion of the left bottom opening of the left wheel well cavity, the left rear cover plate configured to move at least partially in the rightward direction when a rear portion of the left wheel is turned towards the rightward direction.

19. The vehicle of claim 18, further comprising:
an actuation system comprising:
one or more actuators comprising a first right shaft, first left shaft, a second right shaft, and a second left shaft, each of which is movable along the lateral axis,
a first right linkage coupled to the first right shaft and rotatable about a first right fixed hinge,
a first right terminal linkage coupled to the first right linkage and the right rear cover plate,
a first left linkage coupled to the first left shaft and rotatable about a first left fixed hinge,
a first left terminal linkage coupled to the first left linkage and the left front cover plate,
a second right linkage coupled to the second right shaft and rotatable about a second right fixed hinge,
a second right terminal linkage coupled to the second right linkage and the right front cover plate,
a second left linkage coupled to the second left shaft and rotatable about a second left fixed hinge, and
a second left terminal linkage coupled to the second left linkage and the left front cover plate,
wherein, when the first right shaft moves in the rightward direction, the first right linkage rotates about the first right fixed hinge and moves the first right terminal linkage, and the first right terminal linkage moves the right front cover plate at least partially in the leftward direction,
wherein, when the first left shaft moves in the leftward direction, the first left linkage rotates about the first left fixed hinge and moves the first left terminal linkage, and the first left terminal linkage moves the left rear cover plate at least partially in the rightward direction,
wherein, when the second right shaft moves in the rightward direction, the second right linkage rotates about the second right fixed hinge and moves the second right terminal linkage, and the second right terminal linkage moves the right rear cover plate at least partially in the leftward direction, and
wherein, when the second left shaft moves in the leftward direction, the second left linkage rotates about the second left fixed hinge and moves the second left terminal linkage, and the second left terminal linkage moves the left front cover plate at least partially in the rightward direction.

20. The vehicle of claim 18, further comprising a steering assembly comprising a right tie-rod coupled to a right steering knuckle, the right steering knuckle being coupled to the right wheel to turn the right wheel, and a left tie-rod coupled to a left steering knuckle, the left steering knuckle being coupled to the left wheel to turn the left wheel, wherein at least one of the right front cover plate and the right rear cover plate is coupled to the right tie-rod or the right steering knuckle and movable therewith, and wherein at least one of the left front cover plate and the left rear cover plate is coupled to the left tie-rod or the left steering knuckle and movable therewith.
